(19) United States
(12) Patent Application Publication
(10) Pub. No.: US 2004/0174597 A1
(43) Pub. Date: Sep. 9, 2004

(54) Remotely programmable electro-optic sign

(76) Inventors: Rick G. Craig, Draper, UT (US); Iain G. Saul, North Tamborine (AU)

Correspondence Address: THORPE NORTH & WESTERN, LLP., 8180 SOUTH 700 EAST, SUITE 200, P.O. BOX 1219, SANDY, UT, 84070, US

(21) Appl. No.: 10/793,551

(22) Filed: Mar. 3, 2004

Related U.S. Application Data
(60) Provisional application No. 60/451,700, filed on Mar. 3, 2003.

(51) Int. Cl. G02B 27/28; G06F 17/60; G02F 1/07

(52) U.S. Cl. 359/484; 705/14; 359/245

(57) ABSTRACT

A remotely changeable electro-optic sign system and method allows for rapid changing and updating of images on the sign from a remote location. The system includes a sign controller and means for remotely communicating with the controller to allow image data to be communicated thereto. Users and operators of the sign can purchase/sell advertising time on the sign, and provide or change images on the sign from any remote location, such as via computer connection to the Internet.

This application claims priority from U.S. provisional patent application Ser. No. 60/451,700, filed on Mar. 3, 2003, and entitled REMOTELY PROGRAMMABLE ELECTRO-OPTIC SIGN.

### BACKGROUND OF THE INVENTION

1. Field of the Invention

The present invention relates generally to electro-optic signs. More particularly, the present invention relates to a remotely programmable electro-optic sign.

2. Related Art

There are a variety of electro-optic signs that have been in use for many years. Such signs use various display technologies to produce an image by electro-optic means. There are many examples of electro-optic signs and billboards, such as those that employ a matrix of incandescent lamps, a matrix of cathode ray tubes, a matrix of light emitting diodes (LED's) and the like. One of the simplest types of electro-optic signs is a billboard structure having a multiplicity of electrically illuminated incandescent lamps of various colors attached to it. The lamps are arranged so as to produce a single specific image, such as the logo of a product or company. This image can be illuminated at one time, or cam be illuminated sequentially in some manner, such as from the bottom and going towards the top until the entire sign is illuminated, or in practically any other imaginable sequence.

Another well known type of electro-optical screen involves a matrix of colored light emitting diodes (LED's) arranged in a close geometric pattern to produce a picture element (pixel). A multiplicity of such pixels are arranged in a flat planar array to form a screen. When the LED's are electrically energized and sequentially illuminated in response to a video signal, a multi-colored graphical image can be produced. Such colored LED matrices are widely used for very large video display screens in sports stadiums, arenas, and other special events venues.

One problem with conventional electro-optic signs is that they can be application specific. That is, for some electro-optic signs, to change the image thereon can require the physical changing of lamps, and/or changing the sequencing of the lamp-switching program in order to produce a different image. Alternatively, in the case of LED video screens, many electro-optic displays are dedicated to a particular sports stadium or event. While there can also be changeable advertisements shown on such screens, their primary purpose is not to display advertisements, and any advertisements that are shown must be prepared and stored on a transportable data storage media, such as a CD ROM or the like, and taken to the location of the sign to be uploaded for display on the screen.

Similarly, where the electro-optic sign is located in a remote location, such as along a roadside, imaging information still has to be prepared and taken to the location of the sign using some sort of transportable data storage media, and uploaded to the sign's control system. It will be apparent that this sort of control system inherently creates a delay for advertisers because the advertisement cannot be instantly changed, updated, or corrected. While prior electro-optic sign systems may be suitable for the particular purpose they address, they do not allow the virtual instantaneous changing or updating of image from a location remote from the screen.

### SUMMARY OF THE INVENTION

It has been recognized that it would be advantageous to develop an electro-optic sign system and method that allows rapid changing or updating of display images from a location remote from the screen and the controller of the screen.

It has also been recognized that it would be desirable to develop an electro-optic sign system and method that allows advertisers to remotely purchase advertising time on the sign, and also remotely sent the advertisement to the sign.

It has also been recognized that it would be desirable to develop a more practical method for producing, programming, and controlling images displayed on an electro-optic sign.

It has also been recognized that it would be desirable to develop a system and method for broadcasting radio frequency audio signals from an electro-optic sign to accompany visual images displayed thereon.

It has also been recognized that it would be desirable to develop a system and method for controlling an electro-optic sign that can segregate images to be displayed on the sign by apportioning time slots to various users, and charge users by the time of day and duration of display of their particular image.

The present invention advantageously provides an electro-optic sign system, comprising an electro-optic sign, in a publicly viewable location, configured for displaying visual images. The electro-optic sign includes a controller, and is controlled by a sign operator. A general-access computer network is remotely interconnected to the controller of the electro-optic sign, and configured to allow users not associated with the sign operator to directly contract with the sign operator for rights to display an image on the sign, and to transmit data representing the visual image directly to the sign for display thereon.

In accordance with a more detailed aspect thereof, the system can include an interfacing site, controlled by the sign operator, that is remotely connected to the general-access computer network and the controller of the electro-optic sign. The interfacing site is configured to receive the visual image from the user prior to display on the sign, and to allow the sign operator to review and approve the image prior to display on the sign.

In accordance with yet another more detailed aspect thereof, the system can include a data link to a public agency, the public agency having authority to take control of the sign as-needed for displaying public service information.

In accordance with yet another aspect thereof, the invention can be described as an electro-optic sign system, comprising an electro-optic sign, and a controller. The sign is configured for displaying visual images. The controller is configured for controlling the display of images on the sign, and is remotely interconnected to a general-access computer network. This allows a user to purchase rights to display an image on the sign for a discrete time slot, and to transmit data representing the visual image directly to the sign for display thereon, all by using the general-access computer network.

In accordance with still another aspect thereof, the present invention provides a method for displaying an image on an electro-optic sign. The method includes the steps of remotely contracting with a sign user, via a general-access computer network, to provide time-based usage of the sign to display an image prepared by the user, and uploading, by the user, data representing the image directly to the sign via the general-access computer network. The method can also include the step of previewing and approving the image, by an operator of the sign, before allowing the user to upload the image to the sign.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a block diagram of the components of an electro-optic sign system.

FIG. 2 is a block diagram of the components of an electro-optic sign system in accordance with the present invention.

FIG. 3 is a flow diagram of the steps involved in using the sign system.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

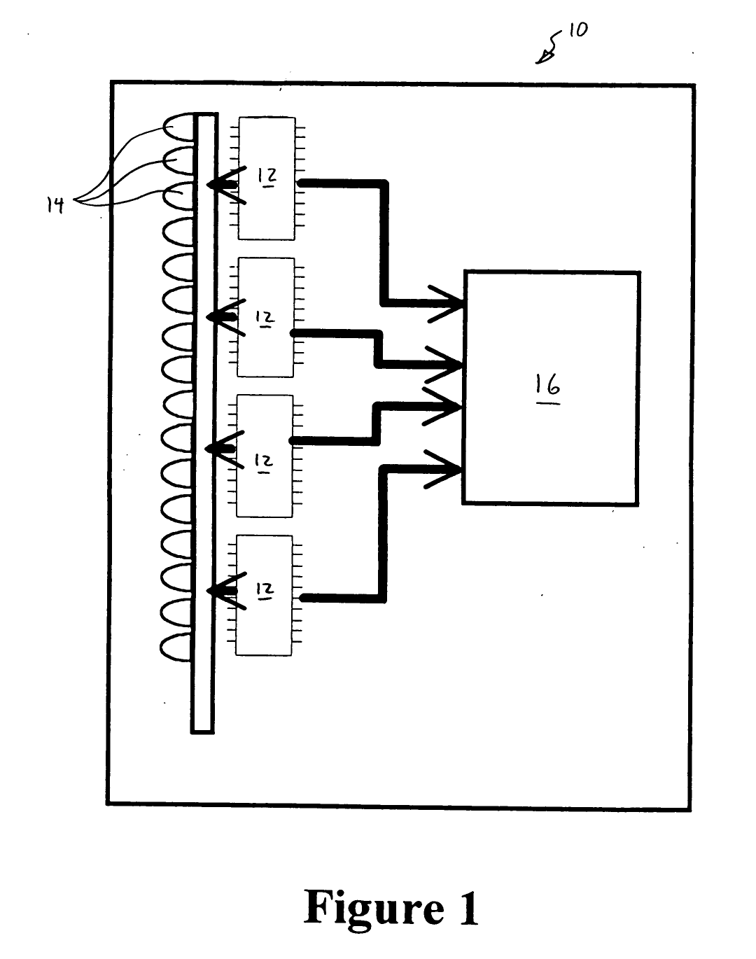

The attached figures illustrate a novel system and method for remotely changing an image and program on an electro-optic sign. Shown in FIG. 1 is a block diagram of the circuitry 10 used in many current electro-optic signs. This circuitry includes a plurality of electronic circuits 12 that drive and control the voltage supplied to a plurality of illuminating means 14, such as lamps, LED's, etc. The electronic drive circuits in turn are controlled by a programmable controller 16 that can receive and store instructions for producing the electronic signal for the desired image or text on the screen. The programmable controller provides switching and control signals to select which of the plurality of illuminating means are switched to their visible and non-visible states at any one time. The programmable controller may consist of a series or multiplicity of electronic modules and circuits that can be instructed and programmed to produce images on the electro-optic sign or screen.

To change or update the image on such an electro-optic sign or screen the instructions contained within the programmable controller 16 have to be changed before being supplied to the switching circuits 12. This can be done in several ways, such physically changing electronic modules associated with the programmable controller, or changing the software associated with the controller.

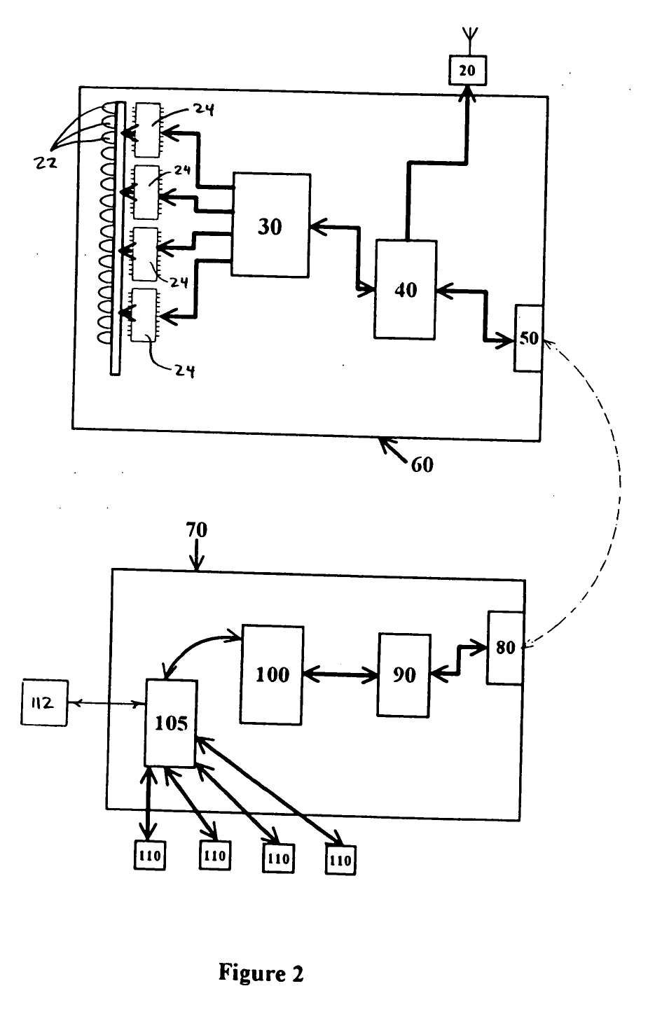

As shown in FIG. 2, a sign or screen 60 in accordance with the present invention includes illuminating means 22, electronic drive circuits 24, and a controller 30. To achieve a change of software in the programmable controller, the inventors have interfaced the programmable controller device to a microprocessor 40, such as a personal computer (PC), or any compatible instruction and interface/communication device capable of providing instruction to programmable controller. The microprocessor can also be interconnected to a communication transmitter/receiver device 50. Alternatively, the programmable controller can be connected directly to the communication transmitter/receiver device. The sign can also include a radio frequency broadcast transmitter 20 for broadcasting a radio frequency audio signal in connection with an image displayed on the sign, as described in more detail below. The radio frequency broadcast transmitter is operatively interconnected to the microprocessor.

The transmitter/receiver device 50 can be a data modem or some other dedicated communication interface device such as a cable or wireless data modem, a wireless radio frequency transmitter/receiver, a satellite communication transmitter/receiver, an optical transmitter/receiver, a dedicated hard-wired electronic transmitter/receiver circuit capable of transceiving a signal. Such signals could be of an analog or digital type, emanating from a source at some distance from the sign 60. The remote signal communication may make contact between the sign and a remote location using many differing types of communication means, such as audio frequency to greater than radio frequency wireless means, coaxial cable and/or hard-wire means and/or fiber optic means and/or sub-optical wavelength to above optical wavelength free space means, and the like to provide a bearer connection path.

The invention advantageously allows the transfer of image information to the programmable controller 30 from a remote location or interfacing site 70 via the transmitter/receiver device 50. The interfacing site includes its own dedicated communication interface device 80 that is capable of communicating signals to and from the sign 60 through the transmitter/receiver device 50. The communication interface device 80 could be a data modem or any other suitable communication device. Communication signals sent between the communication transmitters/receivers 50 and 80 to the sign's microprocessor could use a variety of communication encoding protocols, including a dedicated link RS232, tBase100 network, USB and many other communication protocols or systems. One advantageous method would be via the Internet or World Wide Web and its associated protocols.

The dedicated communication interface device 80 is connected to a server 90, such as a personal computer or other programmable device, which is in turn connected to a master controller 100, a further one or more computers or the like devices. The server comprises a series of electronic circuits and programmable modules and information storage means that accumulate signals and instructions to control the sign 60. The master controller could be a more powerful personal computer device with access control security, a high speed communications interface, and large back-up storage capability. Advantageously, the server is remotely accessible to individual users 110 wishing to place images on the sign. The master controller is interconnected with a data modem 105, or other communication device, to a general access computer network for communicating with users wishing to have advertisements displayed on the sign. Users who wish to place or change images displayed on the sign can communicate to the master controller via the data modem. The general access computer network could comprise the Internet or World Wide Web system, though the invention is not limited to this method. Those skilled in the art will recognize that there are many alternative methods for remote communication. Thus users can remotely control the sign's images, image programming, control and management and communication so as to virtually instantly upload new images or change existing images from locations remote from the sign 60.

The invention contemplates a multiplicity of software programs and/or modules for communication between the users 110 and operators 112 of the sign 60 by way of the master controller 100. This provision allows operators of the sign to control and program it in a manner similar to the manner of use by users wishing to place advertisements upon the sign.

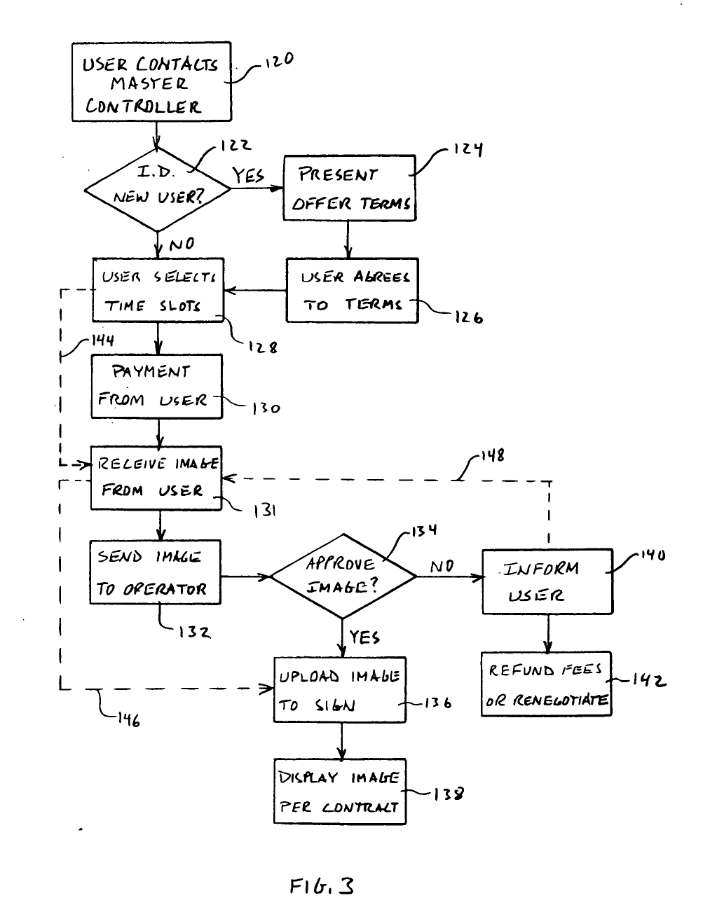

A diagram of some of the steps in the method of using the sign system of the present invention is provided in FIG. 3. With reference to both FIG. 2 and FIG. 3, a user 110 first contacts the master controller 100, such as via a general access computer network (e.g. the Internet). This is step 120 in FIG. 3. In one embodiment, this will involve the user logging onto the sign operator's web site. Upon such contact, the user will be required to enter identifying information. Then, the system queries, at step 122, whether the user can be identified as a prior system user, or a new user. This step can involve an identification module or modules in the system software to verify the identity and authenticity of the user. If the user is new to the system, a contracting module is activated to present information regarding a proposed contract for sign usage services (step 124) and allows the user to provide input indicating assent to the contract (step 126) and other required information. At that point, or if the user is not new to the system, the contracting module allows the user to proceed to the step of selecting desired time slots for display of their image (step 128).

The system software also includes a scheduling module for scheduling the time for display of the advertisement(s) in designated time slots (e.g. 6 second intervals) over a time interval (e.g. 24 hour days). The time period of each image displayed in a time slot is the final aspect of the contract between the user or their agents and the operator of the sign. Users can be charged for displaying images depending upon the time duration of the image, the time of day that the image appears on the sign, the day of the week, season of the year, whether the day is a holiday, and any other suitable method.

Upon selecting the desired time slots, the user 110 is required to pay for the services (step 130). Advantageously, the user can directly pay for the contracted time slot(s) over the computer network, such as by providing a credit card number, or by referencing an account created with the sign operator. This allows a user who is completely unknown to the sign operators, and who may be in any remote part of the world to place an image on the sign.

At that point, a data transmitting module associated with the system software allows the user's image of text, graphics, video, advertisements, etc. to be received by the master controller 100 (step 131). Also included in the software is a review module or modules to allow review and approval of the image by the sign operators. It will be apparent that the parties responsible for a sign that is located in a publicly viewable location will also be responsible to ensure that images displayed on the sign comply with applicable laws and sign operator guidelines. For example, the sign owners can be expected to ensure that indecent or pornographic material is not displayed. Naturally, such laws vary from place to place, and the sign operators must be aware of the standards that are required in the location of the sign. Additionally, the sign operating entity may have their own private standards and policies for images, such as standards relating to content, sponsorship, image quality, etc. Accordingly, following execution of the agreement with the user, a new image or an updated image is first downloaded to the master controller 100, and from there sent to Server 90 (collectively, step 131).

Upon receiving the new uploaded image, the file server 90 will first send the image to one or more selected sign operators 112 for approval (step 132). In one embodiment of the system, a number of persons that are associated with the operation of the sign (the sign operators 112) have data devices (e.g. personal computers, PDAs, mobile phones, smart phones, etc.) that can receive the new images at any time. Upon receipt, at least one of these operators is expected to be in a position to review the image to ensure compliance with applicable laws and policies. The authorized sign operator person then provides feedback to the server via their data device indicating approval or non-approval of the image (step 134). It will be apparent that the system can be configured to require the approval of none, one, two, or any number of sign operator personnel.

If the image is not approved, the user will be informed (step 140), preferably immediately via the computer network. At that point, if time allows, the user can be allowed to correct problems with the image, if possible, and resubmit the image for reconsideration, as indicated by the dashed line 148 in FIG. 3. Alternatively, if this is not possible, the user's fees may need to be refunded, and/or the display contract renegotiated (step 142).

Upon approval of the image by an authorized sign operator, the server will then initiate communication with the sign 60 to upload the image thereto (step 136). Upon receiving verified security code information from the sign's interface/communication device 40, the uploading of the image file can commence from the server via modems 50 and 80 to the interface/communication device. At this point, the image file is stored in a memory buffer of the sign controller, and then displayed according to the contract between the user and the sign operator (step 138).

The sign preferably has a memory buffer that can store images that will allow operation of the sign according to user agreements for a certain duration of time. For example, the memory buffer can be configured to store enough images to allow the sign to operate on its own for more than an hour if the data connection to the interface site is interrupted, allowing a time window within which the data connection can be restored. In one embodiment, the controller is configured to keep, at all times, a more than one hour supply of images corresponding to the next subsequent one hour block. For example, at 12:45 p.m. on a given day the system will receive all images to be displayed between 2:00 p.m. and 3:00 p.m. that day, and retain those images until their time slots arrive. Likewise, at 1:45 p.m. the system will receive all images to be displayed between 3:00 p.m. and 4:00 p.m. Consequently, if the data connection with the server should be lost at 1:44 p.m., the system will still have the images to be displayed between 2:00 p.m. and 3:00 p.m.

In a more simplified embodiment of the method, indicated by dashed lines 144 and 146, after selecting the desired time slots, a user could conceivably skip directly to the step of sending their image to the master controller 110 (step 131), whereupon the master controller sends the image directly to the sign 60 (step 136). It will be apparent that this simplified method presumes that payment (step 130) and approval of the image by the sign operators 112 (steps 132, 134) are not required or otherwise covered.

One advantageous method for this software program to perform the various remote communications and instruction steps outlined herein is via the Internet or World Wide Web. Nevertheless, it will be understood that the invention is not limited to this method of communication, and any other suitable data communication method or protocol can be used in connection with this invention.

A further embodiment of this invention incorporates a radio transmitter 20, such as a low powered commercial wavelength band radio transmitter, discussed above. The radio transmitter is located at or near the sign 60, and is configured to broadcast one or more radio frequency signals, preferably on commercially licensed broadcast bands, to allow audio messages to be heard on a suitably tuned radio receiver within the range of the transmitter. The audio message can provide audio commentary regarding the image displayed on the sign to be received by a suitably tuned radio receiver in close proximity to the sign. Such audio messages could be loaded onto the master controller 100, and be communicated to the instruction and interface/communication device 40 in the same manner as image data. The invention can thus provide a receivable audio message regarding the image being displayed on the sign.

An operative example of the invention can be configured as follows. The sign 60 could comprise a billboard sized sign (e.g. having a display size of about 12 feet high by about 48 feet wide) with a planar display surface including a multiplicity of colored LED's capable of intense illumination. The LED's are arranged in clusters to form picture elements or pixels. Each pixel can produce an enormous variety of shades of colors (e.g. 10 million colors or more) when viewed by the human eye, depending on the relative level of illumination of each colored LED in a pixel. The electronic circuitry of the controller and pixel drivers for the sign system electronically drive and control the switching on or off and the intensity of illumination of the LED pixels in response to a graphical, text, or video image signal. The circuitry and control components for the sign are commonly available components, and in many cases may be provided by the manufacturer of the sign.

To remotely change the image displayed on the sign, a personal computer (PC) 40 is operatively connected to the sign electronic control circuits. The PC has the capability of programming the sign control circuitry to produce any desired image, text or video images. Connected to the PC is a data modem that is connected to a telephone line. Programming, update instructions, and graphical image information for the sign come to the modem via the telephone lines from a compatible remotely located data modem device connected to the server computer. One method for facilitating this communication is via the Internet or World Wide Web protocol.

The server computer 90 is connected to and controlled by the master controller computer 100. A user 110 similarly communicates with the master controller computer remotely. The user or his agent prepares an advertising image that they wish to display on the sign, and remotely upload this image information to the master controller, such as via the Internet or World Wide Web. Upon completing appropriate agreements, control, and verification protocols, and image approval by the sign operators, the image is then sent to the sign via the Internet or World Wide Web.

In addition to video, suitably configured audio signals for commercial wireless broadcast can also be produced by the user or his agent and uploaded and sent to the master controller for broadcast by the interconnected commercial radio frequency band wireless broadcast transmitter associated with the sign. The broadcast radio frequency signals can be configured and transmitted simultaneously on one or more commercially licensed broadcast frequencies and encompass transmission protocols of such systems as the European Traffic Message Channel (TMC) and Traffic Program (TP) for the reception on a suitably-tuned commercial radio receiver located within range of the radio transmitter to provide audio commentary or messages associated with the particular images appearing on the sign.

The operators of the sign system can enter into agreements with the users (e.g. advertisers) to place still or video images upon the sign and/or broadcast audio frequency signals. In most cases these images will be advertisements, and their display or broadcast would be sold based on duration-timed periods (herein termed “time slots”). Thus a particular advertiser user would create a particular advertisement graphics and/or video image (and any audio message to accompany it), and once an agreement had been struck with the operators, the advertisement information can be uploaded via the Internet or World Wide Web to the master controller to be displayed on the sign. As agreed, the advertisement along with any associated audio information would then appear at and on the sign via the various components and communication means as described above at agreed times during, say, a 24-hour period.

After entering into a particular advertising time slot, the user may wish to change the advertisement for some reason. With the present invention, the user or his agent can, via the Internet or World Wide Web, connect with the master controller and gain access in the manner outlined above to change the displayed image on the sign almost instantly from the user's remote location.

The system and method outlined above provides many advantageous features. For example, the system can include a data link, via the Internet or some other data connection, to a public agency or information provider to allow use of the sign for public service alerts or messages. For example, the sign can be used to display Amber Alerts (alerts for missing children) or other crime related announcements where real-time cooperation of the public is desired. Alternatively, the sign can be used to display traffic, weather, late-breaking news, or other important information of public interest. The term public agency can include any law enforcement organization (e.g. police), public safety organization (e.g. fire fighters, transportation dept., health dept., etc.), or any other governmental or non-governmental organization that could have a need for rapidly providing information to the public. An information provider can include news organizations, for example.

When used in this way, the sign control system (i.e. the server) can be configured to be overridden by the public agency or information provider as-needed to allow the public service alert or announcement to take the place of regularly scheduled advertising. For example, the controller can be configured to check periodically, such as every five minutes, a restricted portion of the server 90 that is specially reserved for such public service announcements, then override other scheduled images in preference to these higher priority displays when they appear. The server can also track the details of displays that have been “bumped,” so as to credit the account of the user (e.g. advertiser) whose images were not displayed in the contracted time slot(s). This feature essentially allows a commercial billboard to double as a public service announcement tool for public agencies and/or news organizations. Indeed, a news organization or broadcaster could be an operator of such a sign, using it to display news or information content and advertising according to their own schedule, much in the way broadcasters do via television.

Another advantageous feature of the invention is the in-depth auditing ability of the system. The system software automatically tracks the details of the display of each image. Thus, individual users of the sign can log onto the world-wide web site of the sign operator and see in real-time their display profile—when their image has been shown, how many times, total accumulated total time of showing of one or several images, next showing, when the display has been bumped, etc. The system can allow a full audit by the user of its entire ad campaign, just one advertisement, or any other combination.

In addition, the system can include a monitoring module to provide real-time monitoring of the display. That is, users can view, through the web page, the image that is being displayed on the sign at any given time as it is being displayed in real time. This could be done through a system interconnected with the sign controller that simultaneously sends the image to the sign and the server. Alternatively, a web camera that is physically located near the sign and pointed at it could be interconnected to the web site, allowing users to view the actual sign and its surroundings over the Internet. Such web cams are well known.

The invention thus provides a remotely changeable electro-optic sign system and method that allows for rapid changing and updating of images on the sign by the advertiser or his agent from a remote location. Such sign or bill board could be located at any place that the public may view, and is not limited to association with a particular venue, such as a sports stadium, arena, etc. The display upon such a sign or billboard can be programmed to produce almost any still or video image with a resolution similar to those of static pasted paper or stretched vinyl printed pictorial signs. Such electronic signs, billboards and screens as these have the advantage that the image thereon can be virtually instantly changed to another image, thus obviating the need for costly and time-consuming printing and subsequent mounting and positioning of printed material on the sign board. Advantageously, users and operators of the sign can purchase and sell advertising time, and provide or change images on the sign from any remote location such as via the Internet. Additionally, the electronic images can change rapidly, thus allowing a greater display content to be transmitted from a single display location.

It is to be understood that the above-referenced arrangements are illustrative of the application of the principles of the present invention. It will be apparent to those of ordinary skill in the art that numerous modifications can be made without departing from the principles and concepts of the invention as set forth in the claims.

What is claimed is:

1. A method for displaying an image on an electro-optic sign, comprising the steps of:
a) contracting with a sign user, via a world-wide web site on a general-access computer network, to provide time-based usage of the sign to display an image prepared by the user;
b) uploading, by the user, data representing the image to the web site; and
c) uploading the image directly from the web site to the sign via the general-access computer network.

2. A method in accordance with claim 1, wherein the step of uploading data representing the image further comprises uploading data representing audio information associated with the image, the audio information configured to be broadcast by a radio frequency transmitter associated with the sign while the image is being displayed.

3. A method in accordance with claim 1, wherein the step of uploading data representing the image further comprises uploading data representing a video image.

4. A method in accordance with claim 1, further comprising the step of periodically updating images on the sign according to time-based usage agreements with a plurality of users.

5. A method in accordance with claim 1, further comprising the step of allowing the user to remotely view a real-time image of the display contents of the sign via the general-access computer network.

6. A method in accordance with claim 1, further comprising the step of previewing and approving the image, by an operator of the sign, before allowing the user to upload the image to the sign.

7. A method in accordance with claim 1, wherein the step of contracting with the sign user comprises contracting to display the image in selected time slots over a time interval

8. A method in accordance with claim 7, further comprising the step of causing the controller to refresh the sign at least upon the expiration of each time slot.

9. A method in accordance with claim 1, further comprising the step of storing in a memory buffer associated with the sign a plurality of images for display over a subsequent time interval.

10. A method in accordance with claim 1, further comprising the step of overriding the time-based usage agreement with the user to allow the display of public service information provided via a data link to a public agency or information provider.

11. A method in accordance with claim 10, wherein the step of overriding the time-based usage agreement with the user further comprises:
d) periodically checking a restricted access portion of the web site for data representing a public service information image from an authorized public agency; and
e) displaying the public service information image in preference to the image from the user.

12. An electro-optic sign system, comprising:
a) an electro-optic sign, in a publicly viewable location, having a controller, controlled by a sign operator, and configured for displaying visual images; and
b) a server, controlled by the sign operator, interconnected to a general-access computer network and to the controller of the electro-optic sign, configured to allow a user not associated with the sign operator to exchange data with the sign operator;
c) a contracting module, associated with the server, configured to allow the user to directly contract with the sign operator for rights to display an image on the sign; and
d) a data transmitting module, associated with the server, configured to allow the user to transmit data representing the visual image directly to the sign for display thereon.

13. An electro-optic sign system in accordance with claim 12, wherein the server is configured to provide a World-Wide Web site for providing contact between the user and the sign operator.

14. An electro-optic sign system in accordance with claim 12, wherein the visual image is selected from the group consisting of still images and moving video images.

15. An electro-optic sign system in accordance with claim 12, further comprising a scheduling module, configured to apportion time slots over a time interval for display of the image according to contract terms with the user.

16. An electro-optic sign system in accordance with claim 12, wherein the controller comprises a memory buffer configured to retain in memory a plurality of images for display over a subsequent time interval.

17. An electro-optic sign system in accordance with claim 12, further comprising a data link to a public agency or information provider having authority to take control of the sign for displaying public service information.

18. An electro-optic sign system in accordance with claim 12, further comprising a monitoring module, configured to allow the user to remotely view a real-time image of the display contents of the sign over the general-access computer network.

19. An electro-optic sign system in accordance with claim 12, further comprising:
a) audio data associated with the visual image data; and
b) a radio frequency transmitter, associated with the sign, configured to broadcast a radio frequency signal containing the audio data while the sign simultaneously displays the visual image.

20. An electro-optic sign system, comprising:
a) an electro-optic sign, configured for displaying visual images;
b) a controller, configured for controlling the display of images on the sign, the controller being remotely interconnected to a general-access computer network;
c) a server, remotely connected to the controller via the general access computer network; and
d) a contracting module, associated with the server, configured to allow a user to purchase rights to display an image on the sign for a discrete time slot, and to transmit data representing the visual image directly to the sign for display thereon, by using the general-access computer network.
